(19) United States
(12) Patent Application Publication
(10) Pub. No.: US 2018/0005142 A1
(43) Pub. Date: Jan. 4, 2018

(54) Method for determining venue and restaurant occupancy from ambient sound levels

(71) Applicants: Ali Meruani, London (GB); Benjamin Leigh Greenaway, London (GB)

(72) Inventors: Ali Meruani, London (GB); Benjamin Leigh Greenaway, London (GB)

(21) Appl. No.: 15/422,461

(22) Filed: Feb. 1, 2017

Related U.S. Application Data
(60) Provisional application No. 62/289,978, filed on Feb. 2, 2016.

(51) Int. Cl. G06Q 10/02; G06N 99/00; G06F 3/0488; H04R 29/00; G06F 3/0482

(52) U.S. Cl. CPC G06Q 10/02; H04R 29/00; G06F 3/0482; G06F 3/0488; G06N 99/005

(57) ABSTRACT

The invention is a method and device system for determining publishing and taking reservation requests against a venue offering a restricted or resource-limited service or, a restaurant, bar or café whose occupancy is limited. The method can function unattended and provide the measure of availability from ambient sound levels, using digital acoustic sensors (microphones) and a machine learning process to predict and publish the availability of the resource or occupancy level of the space in which it is contained.

### CROSS-REFERENCE TO RELATED APPLICAITONS

This application claims the benefit of nonprovisional Application No. 62/289,978 with title “A provisional patent application for the Menuspring-eet method of Service Availability Publication and Real-Time Reservation Confirmation”, filed Feb. 2, 2016.

### BACKGROUND OF THE INVENTION

A wide variety of businesses exist in which the volume or turn-around time of their operating space impinges upon or limits their ability to deliver a service or utility. For example, the availability of tables in a restaurant can, for any given day's service, restrict their potential sales, or a gym's limited workout apparatus deter the subscription of new members, or hasten the loss of existing ones.

However, in many of these situations this limit is not wholly a product of the size or the quantity of the resource in question. It can, at least in part, be due to difficulties in communicating, in real-time, the availability of the resource.

Alternatively, a venue's perceived or expected occupancy, as imagined by potential customers, may also limit sales volume and revenues. Whenever potential customers falsely believe that a venue is fully occupied, but in fact it can accommodate them, and yet they choose not to attend, the sale is lost. In such circumstances, had the true occupancy been known, the customer might have attended and the sale been saved. Similarly, whenever potential customers falsely believe a resource to be available, yet upon arrival discover otherwise and subsequently decide to walk away, the sale is equally lost. In these circumstances, when a provider can show a wait-time for availability, or allow potential customers to reserve their place in-line, or book the earliest available resource they often do so, and the potential sale is kept.

In addressing these issues, many businesses have adopted one form or another of either a booking, queueing or advanced reservation system, or some combination of all three. Booking and advance reservation systems offer a part-solution by providing a means to secure the required service or resource at some future date. This may offer customers the confidence they desire in the resource's availability lacking in the previous scenarios, but the resource may not be available at the time requested. Conversely for the resource manager, reservation and booking systems are brittle to customer cancellations and require potentially quite complex systems of prediction to partition efficiently set-aside “bookable” spaces from walk-in ones. Such planning and partitioning solutions can be extremely accurate, but cancellations will always lead to the loss of potential revenues and to “dead” time for valuable time-sensitive and in-demand resources.

Other businesses maintain strict “no-booking” policies and will turn down requests from customers phoning to save a resource, even when it is for immediate use. Others still may use a queuing system of some sort for those customers willing to make the trip to their place of business. This can take the form of a physical queue, an electronic token or portable device allowing queueing customers to wander while waiting, or something as simple as a pencil, paper and loudspeaker, or visual display.

In keeping with the Duty of Disclosure, the following patents are listed as pertaining to the body of prior art knowledge known to the inventors and to that encompassed by the current invention.

1: “Apparatus and method for an internet based computer reservation booking system”: U.S. Pat. No. 7,069,228 of Jun. 27, 2006: in which is described the use of Internet websites by restaurants, bars and cafes to facilitate reservation and advance booking.

2: “Submitting a request to reserve a service”: U.S. Patent Application No. 20080215446 of Sep. 4, 2008: in which are described a class of client systems placing table requests to a restaurant reservation service and methods and systems for making a determination of availability.

3: “Receiving a request to reserve a service”: U.S. Pat. No. 7,818,191 of Oct. 19, 2010: in which is detailed the nature and content of such requests and a means for responding to them.

4: “Method and apparatus for monitoring the status of tables”: U.S. Pat. No. 5,272,474 of Dec. 21, 1993: in which is described the collection and use of data pertaining to the availability of a table, which is derived from a series of related, captured data points, for the purpose of better managing a venues resources.

5: “Method for accurately quoting wait time for a restaurant table”: U.S. Patent Application No. 20070250355 of Oct. 25, 2007: in which is described a process for calculating the wait time for a table at a restaurant by better understanding and modelling the manner in which tables ‘turn’.

6: “Restaurant management information and control method and apparatus”: U.S. Pat. No. 4,530,067 of Jul. 16, 1985: in which is described a remote unit in use by wait staff to send and record with a computing system customer orders, and pass them about the restaurant.

7: “Restaurant yield management portal”: U.S. Pat. No. 8,326,705 of Dec. 4, 2012: in which is described a centralised booking system to manage incentivised sales for restaurant resources, to target off-peak sales and to improve resource utilisation.

Additionally, the work of Jens Holger Rindel (of Odeon A/S, Kongens Lyngby, Denmark) on a simplified model of the Lombard Effect in his paper, “Acoustic capacity as a means of noise control in eating establishments,” presented to the Joint Baltic-Nordic Acoustics meeting of Jun. 18-20, 2012 in Odense, Denmark, and the work of L. H. Christie & J. R. H. Bell-Booth in their paper titled, “Acoustics in the Hospitality Industry: A subjective and Objective Analysis,” published in the Journal Articles of The Acoustical Society of New Zealand, Issue 4, Volume 18 (2005) is cited as relevant acoustical theory to the background of the invention and to the serviceability of ambient noise in a venue or place of business as an indicator to its state of occupancy, and, by extension, to the availability of resources in such a space.

(Jens Holger Rindel's paper may be found at www.odeon.dk/pdf/C116-BNAM_2012_Rindel_29.pdf)

### BRIEF SUMMARY OF THE INVENTION

The purpose of the invention is to assign an availability state or occupancy level from a processed measure of a venue's ambient sound. The motivation for doing so comes in two parts. Firstly, that customers wishing to book, reserve or make use of a service or service resources at short notice, or with no notice at all, not currently at the location of a business or service provider may have no knowledge, limited knowledge or fake knowledge of that business's activity level or resource's availability at any given time. And secondly that customers wishing to enquire about that current activity or availability level create a need for a member of staff to be both sufficiently well informed and readily available to respond, or otherwise such enquiries can not be satisfied.

In determining the state of availability or occupancy by analyzing the ambient sound of a space rather than requiring an input from staff or the installation of computer-aided vision, cameras, door, table or chair sensors the invention succeeds in minimizing its installation footprint and its maintenance requirement while simultaneously maximising is coverage of the space because sound, unlike vision or proximity is directionless.

Once assigned, the determination of availability and or occupancy is published via the Internet to parties interested in the state of the venue's occupancy or service's availability. Such parties might be the venue owner themselves in the form of their business's website, or a third party in the form of a listing service or availability agent or smart phone app or third party application or application programming interface.

The benefit of communicating this availability in real time is that it is closing the gap between expected or perceived service availability and actual venue or resource availability. Where previously a sale could be lost, it can be made.

The maximum volume of resource set aside for reservation and pre-bookings may be increased, since doing so presents less risk of locking inventory and, additionally, the rate of “table turn” or “repeat use” is increased since idle resources are more broadly promoted at times they might otherwise be expected to occupied.

Distributing a measure of availability rather than a series of future, bookable time slots enables new behaviours similar to that of joining a queue remotely—of making a late booking where a booking can not be made, or of freeing a customer from the frustration of a journey only to arrive and join the back long standing line.

### BRIEF DESCRIPTION OF DRAWINGS

FIG. 1: Defining Real-Time Availability. This figure chart a selection of variables under consideration when making a determination of real-time availability or venue occupancy and shows the manner in which a determination is published.

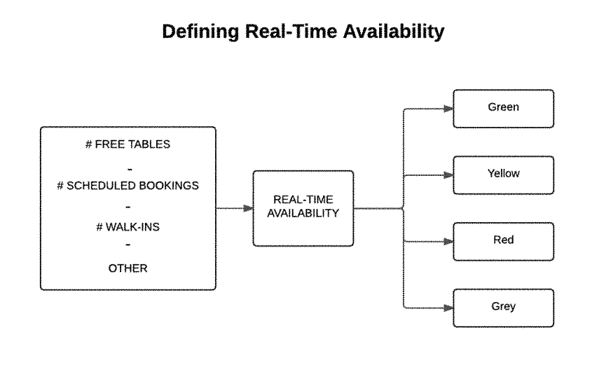

FIG. 2: The Pager's U.I. with Availability States. This figure shows the example user interface of the touchscreen device, as programmed to accept input signals for assigning availability or occupancy state, as well as for displaying requests for service or booking as they are arriving.

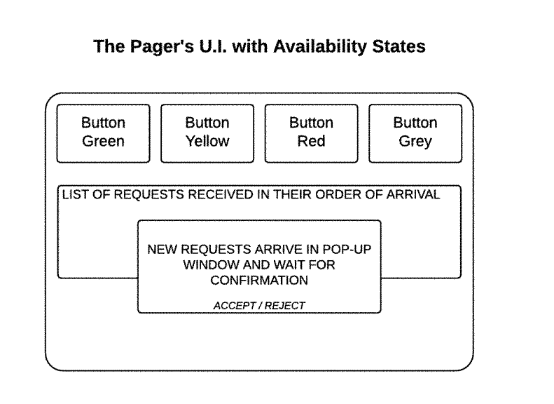

FIG. 3: The Scheduler's U.I. with Availability States. This figure shows the example user interface of the scheduler component of the application where predeterminations may be made for known availability or occupancy states in hourly sections.

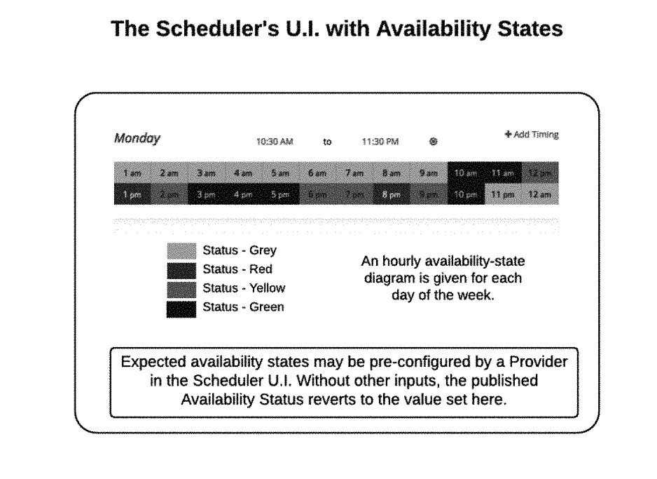

FIG. 4: Availability and Real-Time Reservation Service. This figure shows the conceptual map constituting a complete real-time availability and reservations service and identifies the Pager, optional Wearable, reservation system and acoustic environment sensor as they relate to the system's whole.

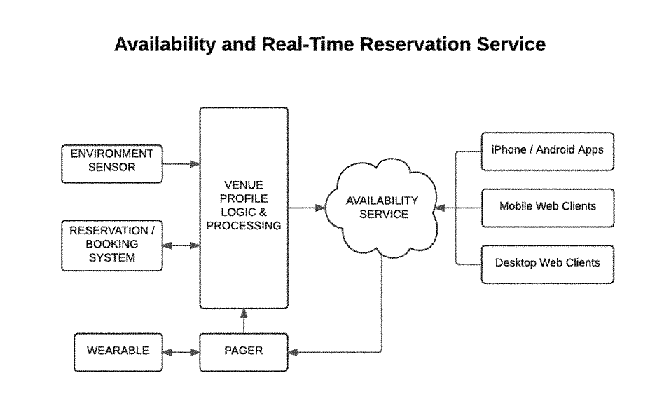

FIG. 5: Venue Profile, Logic and Processing: Acoustic Profile Learning Diagram. This figure shows a detail of the logic used by the system to train the machine learning model. It relates in a state diagram the recorded, ambient sound level and new inputs to change the determination of availability.

FIG. 6: Venue Profile, Logic and Processing: adjustment of status rules diagram. This figure shows the complete state diagram for determining an availability, and includes determinations when in-bound requests are either rejected or timeout without response.

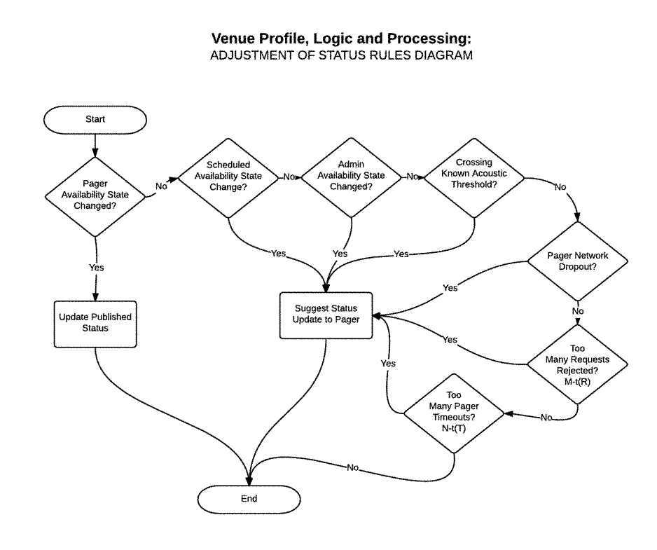

FIG. 7: On-Demand Availability Clients : This figure shows the manner in which the determined availability is distributed and to whom it is distributed.

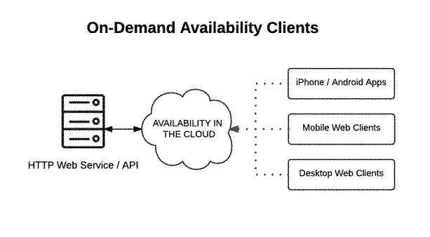

### DETAILED DESCRIPTION OF THE INVENTION

The invention determines a general purpose indicator of resource availability or of venue occupancy similar to that of a Traffic Light. Resource availability, or venue occupancy, is categorized into four color-coded states: Green; resources are currently available, Yellow; resources will be available after a short wait of between 15 and 45 minutes, Red; resources will not be available until after a longer wait of 45 minutes or more, and Grey; the resource will no larger be available during the current hours of service.

### FIG._1

There is a Pager device, which may be either a smart phone, phablet or tablet device, so long as it is programmable, capable of displaying messages, of accepting inputs and relaying them to a central computer or server.

### FIG._2

Ideally the smart phone, phablet or tablet is equipped with a good quality digital microphone which should record short 2 to 3 second recordings each period of 5 seconds and extract the min, max and mean sound power level from them, sending those values on to the central computer or server once every minute. The recordings themselves may be discarded. A digital microphone remote to the Pager device may be used instead, in which case the processing of captured audio would need to take place that the receiving central computer or server.

As the hours of service begins, a default state is assigned by a scheduler or read from the machine learning model and is set for the venue. At the start of service, this status will be most likely be Green.

### FIG._3

As service progresses, the management of adjustments to the availability state is handled in two parts. Inputs to the model for availability may be made by the Pager/Touchscreen device and optional remote wearable device as a request to change the published availability state by tapping the corresponding state button on the Pager device in response to real-world changes in the resources availability. If requests to book the service or resource arrive they should be forwarded to the Pager.

### FIG._4

If for instance a restaurant venue is becoming busy, and if the wait for tables increases, a member of the wait staff or the Concierge should adjust the published availability state accordingly using the Pager device.

As the rush eases or cancellations occur releasing tables otherwise set aside, the change in availability should be again adjusted, and continuously adjusted so that throughout service it reflects the state of the venue.

In addition to the manual adjustments through the Pager/Touchscreen device, pro-active adjustments are suggested based on the results of machine learning specific to each venue or space. Regression analysis of a venues history of correlated availability assignments and changes in the ambient sound level provides suitable hypotheses for the machine learning model to falsify and gain refinement.

### FIG._5

In addition, the scheduler allows for the pre-planned assignment of availability status at peak times on peak days where it may be known well in advance that a resource is likely to have restricted availability. Any data in the scheduler may be added to the collection of signals used in the training of the machine learning model.

Once trained, the acoustic profiling A.I. may suggest status changes to the Pager whenever changes in the audio level are recognized and that corresoond with previous monitored status changes, request rejections and request timeouts, simplifies the task of setting availability states for the user.

Unless instructed by more recent inputs, and so long as any scheduled adjustment is within one state change of the current availability state, a status change can be assigned by the model and the published indicator updated.

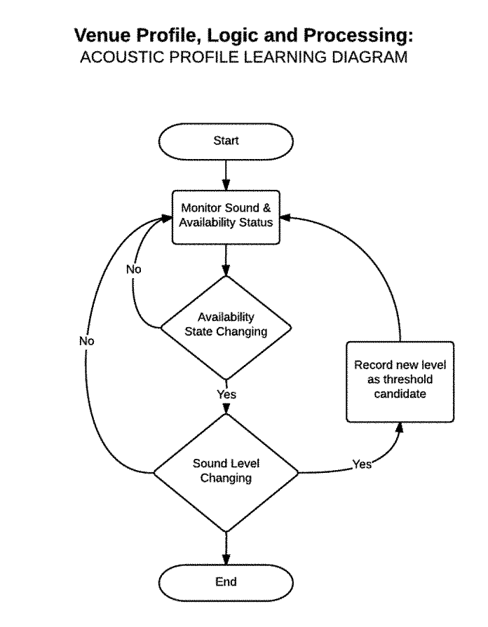

The complete state-change diagram required by the invention therefore is given below. We have found the best value for t(T), N and for t(R) and M, the timeouts and repetition of timeouts used in FIG. 5 to determine activity levels and accuracy levels based on responses to the Pager device to be 30 seconds and 3 for t(T) and N respectively, and 30 seconds and 2 for t(R) and M, though very large venues may require a second or third Pager device to maintain a timely response at higher activity levels.

### FIG._6

The availability-state service is made available as a Web Application Programming interface or Web API. It is delivered to the Internet (Cloud) via a secured or unsecured HTTP connection in JSON or XML.

Clients of the service can include iOS, Android and Windows mobile phones or tablet devices, web applications, desktop and laptop web browser clients and others. Each may look up the availability state of any subscribed provider by providing a valid set of authentication credentials and the provider's identity reference code. The Pager device but not the optional companion Wearable device is also connected to this Web API to receive incoming request for a resource booking or to be joined to the resource availability queue.

### FIG._7

[symbol]

What is claimed is:

1: an apparatus able to determine either the occupancy level of the venue or space in which it resides or the availability of services within the venue or space in which it resides from a combination of the venue or space's ambient sound level, a recent history of the venue or space's ambient sound level and a series of training inputs recorded over the duration of the recent history of the venue or space's ambient sound level.

2: an apparatus of claim 1 comprising: a combined wireless digital audio recording device and wireless touchscreen; a networked central computing device; and a custom software application running on the networked central computing device.

3: an apparatus of claim 1 comprising: a wireless digital audio recording device; a wireless touchscreen input device; a networked central computing device; and a custom software application running on the networked central computing device.

4: the combined wireless digital audio recording device and wireless touchscreen of claim 2 wherein values for the minimum, maximum and mean power levels of sound most recently recorded are updated and relayed regularly to the networked central computer and custom software application.

5: the wireless digital audio recording device of claim 3 wherein values for the minimum, maximum and mean power levels of sound most recently recorded are updated regularly by the networked central computer and custom software application receiving the devices recordings.

6: the combined wireless digital audio recording device and wireless touchscreen of claim 2 wherein touchable button inputs may be pressed to assign a level of availability to a resource indicated on the screen and relayed to the networked central computing device.

7: the wireless touchscreen device of claim 3 wherein touchable button inputs may be pressed to assign a level of availability to a resource indicated on the screen and relayed to the networked central computing device.

8: the combined wireless digital audio recording device and wireless touchscreen of claim 2 wherein touchable button inputs may be pressed to assign a level of occupancy to a venue or space indicated on the screen.

9: the wireless touchscreen device of claim 3 wherein touchable button inputs may be pressed to assign a level of occupancy to a venue or space indicated on the screen.

10: the custom software application of claim 2 wherein values for the minimum, maximum and mean sound power level from the combined wireless digital audio recording device and wireless touchscreen is processed and recorded to constitute an ambient sound level history.

11: the custom software application of claim 3 wherein values for the Minimum, maximum and mean sound power level from the wireless digital audio recording device is processed and recorded to constitute an ambient sound level history.

12: the custom software application of claim 10 wherein the ambient sound level history is combined with levels for availability and or occupancy from inputs to the touchscreen to train a machine learning model for availability and or occupancy of the venue and or space.

13: the custom software application of claim 11 wherein the ambient sound level history is combined with levels for availability and or occupancy from inputs to the touchscreen to train a machine learning model for availability and or occupancy of the venue and or space.

14: the networked central computing device of claim 2 wherein the networked central computing device is located remotely of the combined wireless digital audio recording device and wireless touchscreen and connected to said combined device via an Internet connection.

15: the networked central computing device of claim 3 wherein the networked central computing device is located remotely of the wireless touchscreen device and the wireless digital audio recording device and is connected to them both via an Internet connection.

16: the custom software application of claim 2 wherein a schedule of optional training inputs for training a machine learning model for availability and or occupancy may be defined in calendar form and included along with the machine learning model's other inputs when they become due.

17: the custom software application of claim 3 wherein a schedule of optional training inputs for training a machine learning model for availability and or occupancy may be defined in calendar form and in along with the machine learning model's other inputs when they become due.

18: the custom software application of claim 2 wherein is made available to a web application programming interface (Web API or “web-service endpoint”) the determined availability and or occupancy level.

19: the custom software application of claim 3 wherein is made available to a web application programming interface (Web API or “web-service endpoint”) the determined availability and or occupancy level.
